(19) United States
(12) Patent Application Publication
(10) Pub. No.: US 2019/0350172 A1
(43) Pub. Date: Nov. 21, 2019

(54) ELECTRONIC RETRACTABLE PET LEASH DEVICE

(71) Applicant: WINGPET MANUFACTORY CO., LIMITED, Dongguan City (CN)

(72) Inventors: Min Liu, Dongguan City (CN); Si Hai Chen, Dongguan City (CN); Ren Yuan Yang, Dongguan City (CN)

(21) Appl. No.: 16/278,694

(22) Filed: Feb. 18, 2019

(30) Foreign Application Priority Data
May 17, 2018 (CN) 201820735378.X

(51) Int. Cl. A01K 27/00

(52) U.S. Cl. CPC A01K 27/004; A01K 27/006

(57) ABSTRACT

An electronic retractable pet leash device includes a housing and a reel. The housing has a handle and an accommodating space inside the housing. The housing is formed with a leash hole communicating with the accommodating space. The reel is rotatably disposed in the accommodating space. A leash is wound about the reel. A free end of the leash passes through the leash hole to extend outward. The accommodating space is provided with a control board, a latching member and a motor-driven mechanism. The latching member is movably disposed beside the reel. When the latching member is moved to approach the reel, the latching member is engaged with the reel to lock the reel. When the latching member is moved away from the reel, the reel is unlocked. The motor-driven mechanism is electrically connected to the control board.

### BACKGROUND OF THE INVENTION

### 1. Field of the Invention

The present invention relates to pet supplies, and more particularly to an electronic retractable pet leash device.

### 2. Description of the Prior Art

With the improvement of living standards and the basic guarantee of materials, many people keep pets to deal with loneliness or pursue hobbies. Walking a pet after a meal is essential for such people. In order to prevent pets from running about or losing, people often use a pet leash to limit the behavior of the pet to go far or wrong. Thus, various pet leashes are developed on the market.

The reel of a conventional retractable pet leash is controlled by a mechanical structure, which is laborious and troublesome for operation. The reliability and stability are not good. Accordingly, the inventor of the present invention has devoted himself based on his many years of practical experiences to solve these problems.

### SUMMARY OF THE INVENTION

In view of the shortcomings of the prior art, the primary object of the present invention is to provide an electronic retractable pet leash device, which can effectively solve the problem that the convention pet leash is troublesome in operation and has poor reliability and stability.

In order to achieve the above object, the present invention adopts the following technical solutions:

An electronic retractable pet leash device comprises a housing and a reel. The housing has a handle and an accommodating space inside the housing. The housing is formed with a leash hole communicating with the accommodating space. The reel is rotatably disposed in the accommodating space. A leash is wound about the reel. A free end of the leash passes through the leash hole to extend outward. The accommodating space is provided with a control board, a latching member and a motor-driven mechanism. The latching member is movably disposed beside the reel. When the latching member is moved to approach the reel, the latching member is engaged with the reel to lock the reel. When the latching member is moved away from the reel, the reel is unlocked. The motor-driven mechanism is electrically connected to the control board. The motor-driven mechanism drives the latching member to approach or away from the reel.

Preferably, the motor-driven mechanism includes a reduction gear box, a motor, and a gear. The motor drives the reduction gear box to run. The gear is mounted on an output shaft of the reduction gear box. The latching member has a rack. The gear is meshed with the rack.

Preferably, a cover is fixed in the accommodating space. The cover is pressed against the motor-driven mechanism.

Preferably, a micro switch is disposed in the accommodating space. The micro switch is located beside the latching member and connected to the control board. The latching member has a contact for triggering the micro switch.

Preferably, the micro switch includes two spaced micro switches. One of the two micro switches is located above the other micro switch.

Preferably, a circumferential edge of one side of the reel is provided with a plurality of recesses. The latching member has a protrusion matched with one of the recesses.

Alternatively, circumferential edges of two sides of the reel are provided with a plurality of recesses. The latching member has two protrusions. In a locked state, the two protrusions are engaged with the corresponding recesses at the two sides of the reel, respectively.

Preferably, the housing is provided with an illumination lamp. The illumination lamp is electrically connected to the control panel.

Preferably, the housing includes two half housings coupled to each other. One of the two half housings is provided with a rotating shaft. The reel is rotatably mounted on the rotating shaft.

Preferably, the motor-driven mechanism is an electromagnetic switch.

Compared with the prior art, the present invention has obvious advantages and beneficial effects. Specifically, it can be known from the above technical solutions:

The motor-driven mechanism drives the latching member to approach or away from the reel, so that the reel is locked or unlocked. The operation is more labor-saving and simple. The stability and reliability are better. It is convenient for use.

Embodiments of the present invention will now be described, by way of example only, with reference to the accompanying drawings.

### BRIEF DESCRIPTION OF THE DRAWINGS

FIG. 1 is a perspective view in accordance with a first embodiment of the present invention;

FIG. 2 is an exploded view in accordance with the first embodiment of the present invention;

FIG. 3 is a partially assembled view in accordance with the first embodiment of the present invention;

FIG. 4 is a partially assembled schematic view of FIG. 3;

FIG. 5 is an exploded view in accordance with a second embodiment of the present invention; and

FIG. 6 is a partially assembled view in accordance with the second embodiment of the present invention.

### DETAILED DESCRIPTION OF THE PREFERRED EMBODIMENTS

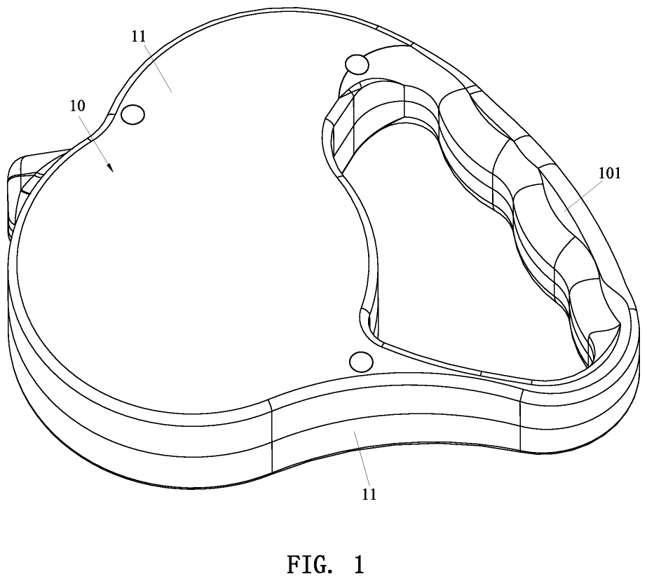

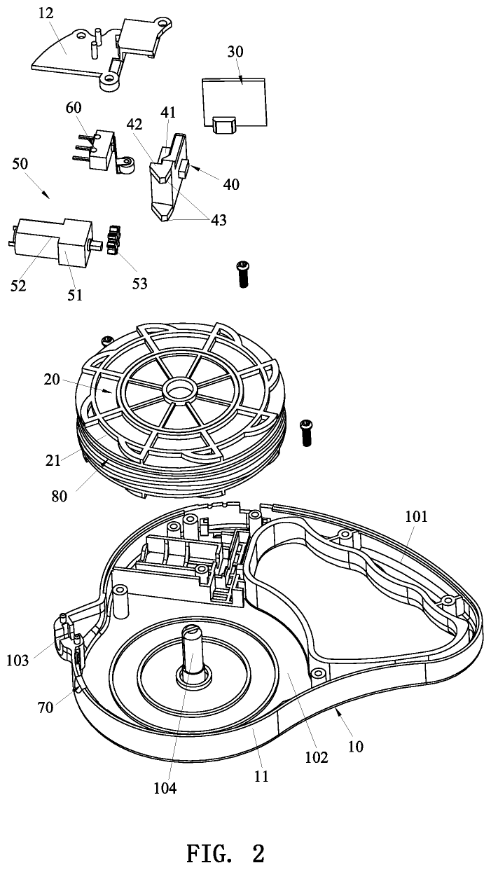

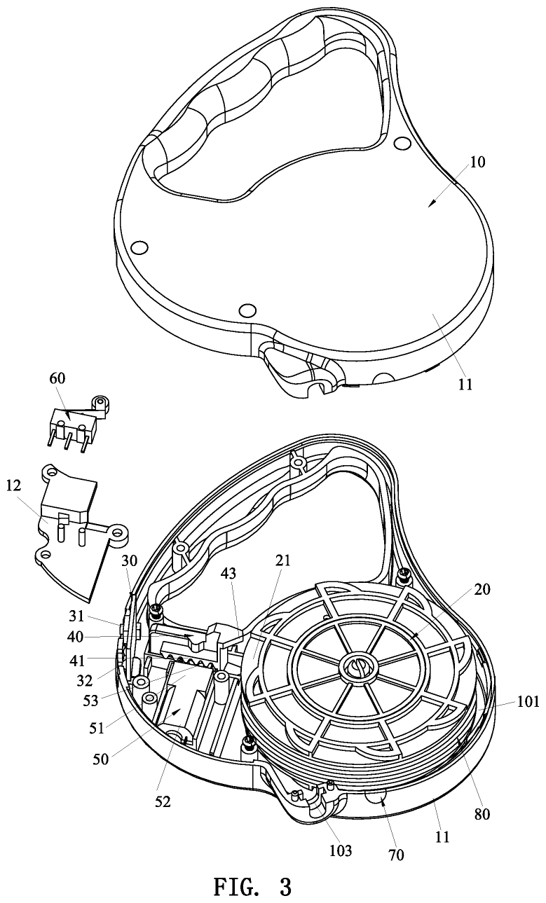

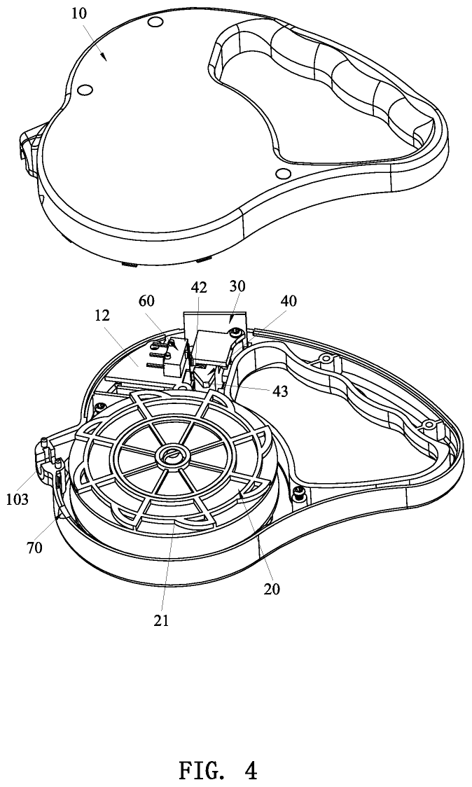

Referring to FIG. 1 through FIG. 4, a specific structure of a first embodiment of the present invention comprises a housing 10 and a reel 20.

The housing 10 has a handle 101 and an accommodating space 102 inside the housing 10. The housing 10 is formed with a leash hole 103 communicating with the accommodating space 102. In this embodiment, the housing 10 includes two half housings 11 coupled to each other. One of the two half housings 11 is provided with a rotating shaft 104.

The reel 20 is rotatably disposed in the accommodating space 102. A leash 80 is wound about the reel 20. A free end of the leash 80 passes through the leash hole 103 to extend outward. In this embodiment, the reel 20 is rotatably mounted on the rotating shaft 104.

The accommodating space 102 is provided with a control board 30, a latching member 40, and a motor-driven mechanism 50. The latching member 40 is movably disposed beside the reel 20. When the latching member 40 is moved to approach the reel 20, the latching member 40 is engaged with the reel 20 to lock the reel 20. When the latching member 40 is moved away from the reel 20, the reel 20 is unlocked. The motor-driven mechanism 50 is electrically connected to the control board 30. The motor-driven mechanism 50 drives the latching member 40 to approach or away from the reel 20.

Specifically, the motor-driven mechanism 50 includes a reduction gear box 51, a motor 52, and a gear 53. The motor 52 drives the reduction gear box 51 to run. The gear 53 is mounted on an output shaft of the reduction gear box 52. The latching member 40 has a rack 41. The gear 53 is meshed with the rack 41. Moreover, a cover 12 is fixed in the accommodating space 102. The cover 12 is pressed against the motor-driven mechanism 50.

A micro switch 60 is disposed in the accommodating space 102. The micro switch 60 is located beside the latching member 40 and connected to the control board 30. The latching member 40 has a contact 42 for triggering the micro switch 60. The micro switch 60 includes two spaced micro switches. One micro switch is located above the other micro switch for controlling the up and down stroke.

In addition, the circumferential edge of one side of the reel 20 is provided with a plurality of recesses 21. The latching member 40 has a protrusion 43 matched with one of the recesses 21. In this embodiment, the circumferential edges of two sides of the reel 20 are provided with a plurality of recesses 21. The latching member 40 has two protrusions 43. In a locked state, the two protrusions 43 are engaged with the corresponding recesses 21 at the two sides of the reel 20, respectively.

Furthermore, the control board 30 has a tact switch 31 and LEDs 32. The tact switch 31 is exposed to the housing 10. The housing 10 is provided with an illumination lamp 70 to provide an illumination function. The illumination lamp 70 is electrically connected to the control panel 30 to provide the required illumination for walking a pet at night. In this embodiment, the illumination lamp 70 is located beside the leash hole 103, but not limited thereto.

The working principle of this embodiment is described below.

The invention is provided with a rechargeable battery of 3.7V 150 MA (not shown) and connected with an external USB charging cable to be charged normally. When charging, the corresponding LED 32 is on. When the battery is full, the LED is off. In normal use, the tact touch switch 31 is pressed for three seconds to start, and the corresponding LED is on. When the tact switch 31 is pressed, the motor 52 is rotated forward, and the gear 53 on the output shaft is rotated counterclockwise by the reduction gear box 51, and the gear 53 links the rack 41 of the lathing member 40 to move downward until the contact 42 of the latching member 40 gets contact with the micro switch 60. One of the LEDs 32 is off, the other LED 32 is on, and the motor 52 is stopped. At this time, the protrusions 43 of the latching member 40 come into contact with the recesses 21 of the reel 20 so that the reel 20 is jammed. The tact switch 31 is pressed again, the motor 52 is rotated reversely, and the latching member 40 is moved upward until the contact 42 of the latching member 40 gets contact with the micro switch 60. The above two LEDs 32 are turned on and off on the contrary, and the motor 52 is stopped. At this time, the protrusions 43 of the latching member 40 are disengaged from the recesses 21 of the reel 20, so that the reel 20 is rotatable. This function may be repeated. Under any circumstances, the tact switch 31 is pressed for three seconds, and the motor 52 is rotated reversely for three seconds, and the corresponding LED 32 flashes for three seconds and then goes out. The product is turned off.

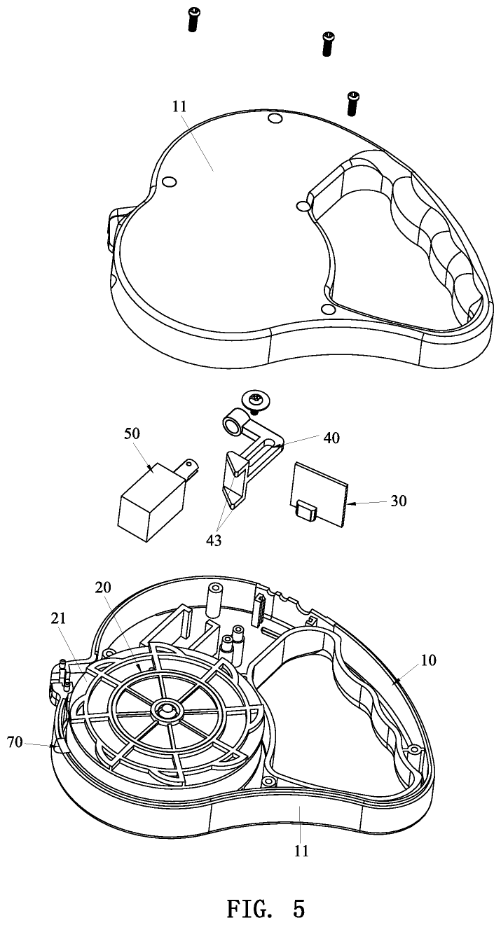

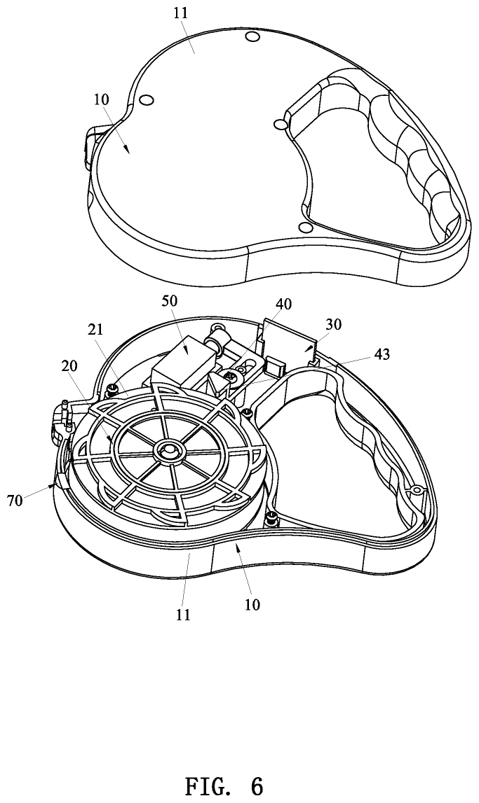

Referring to FIG. 5 and FIG. 6, a specific structure of a second embodiment of the present invention is shown. The specific structure of the second embodiment is substantially similar to the specific structure of the first embodiment with the exceptions described hereinafter.

In this embodiment, the motor-driven mechanism 50 is an electromagnetic switch. The telescopic movement of the opening and closing of the electromagnetic switch realizes the back and forth movement of the latching member 40. This structure is simpler.

The feature of the present invention is described below. The motor-driven mechanism drives the latching member to approach or away from the reel, so that the reel is locked or unlocked. The operation is more labor-saving and simple. The stability and reliability are better. It is convenient for use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. An electronic retractable pet leash device, comprising a housing and a reel; the housing having a handle and an accommodating space inside the housing, the housing being formed with a leash hole communicating with the accommodating space; the reel being rotatably disposed in the accommodating space, a leash being wound about the reel, a free end of the leash passing through the leash hole to extend outward; the accommodating space being provided with a control board, a latching member and a motor-driven mechanism; the latching member being movably disposed beside the reel, wherein when the latching member is moved to approach the reel, the latching member is engaged with the reel to lock the reel, wherein when the latching member is moved away from the reel, the reel is unlocked; the motor-driven mechanism being electrically connected to the control board, the motor-driven mechanism driving the latching member to approach or away from the reel.

2. The electronic retractable pet leash device as claimed in claim 1, wherein the motor-driven mechanism includes a reduction gear box, a motor and a gear, the motor drives the reduction gear box to run, the gear is mounted on an output shaft of the reduction gear box, the latching member has a rack, and the gear is meshed with the rack.

3. The electronic retractable pet leash device as claimed in claim 1, wherein a cover is fixed in the accommodating space, and the cover is pressed against the motor-driven mechanism.

4. The electronic retractable pet leash device as claimed in claim 1, wherein a micro switch is disposed in the accommodating space, the micro switch is located beside the latching member and connected to the control board, and the latching member has a contact for triggering the micro switch.

5. The electronic retractable pet leash device as claimed in claim 4, wherein the micro switch includes two spaced micro switches, and one of the two micro switches is located above the other micro switch.

6. The electronic retractable pet leash device as claimed in claim 1, wherein a circumferential edge of one side of the reel is provided with a plurality of recesses, and the latching member has a protrusion matched with one of the recesses.

7. The electronic retractable pet leash device as claimed in claim 6, wherein circumferential edges of two sides of the reel are provided with the plurality of recesses, the latching member has two protrusions, in a locked state, the two protrusions are engaged with the corresponding recesses at the two sides of the reel, respectively.

8. The electronic retractable pet leash device as claimed in claim 1, wherein the housing is provided with an illumination lamp, and the illumination lamp is electrically connected to the control panel.

9. The electronic retractable pet leash device as claimed in claim 1, wherein the housing includes two half housings coupled to each other, one of the two half housings is provided with a rotating shaft, and the reel is rotatably mounted on the rotating shaft.

10. The electronic retractable pet leash device as claimed in claim 1, wherein the motor-driven mechanism is an electromagnetic switch.
